(19) United States
(12) Patent Application Publication
(10) Pub. No.: US 2014/0133721 A1
(43) Pub. Date: May 15, 2014

(54) COMPARATIVE IMAGE DISPLAY SYSTEM AND A MOLECULAR IMAGING DEVICE CONTAINING THIS SYSTEM

(71) Applicant: Bruker Biospin Corporation, (US)

(72) Inventors: San-Qiang Fen, Shanghai (CN); Min Yang, Shanghai (CN); Hong-Lin Liang, Shanghai (CN)

(73) Assignee: Bruker Biospin Corporation, Billerica, MA (US)

(21) Appl. No.: 13/853,649

(22) Filed: Mar. 29, 2013

(30) Foreign Application Priority Data
Mar. 30, 2012 (CN) 201220128665.7

(51) Int. Cl. G06T 7/00

(52) U.S. Cl. CPC G06T 7/0012
USPC 382/131

(57) ABSTRACT

A comparative image display system comprises a monitor, an import unit and an image matching unit. The import unit receives from the user a tag and display mode of a first image selected by the user from a first imaging data group, and informs the monitor to display the first image on the display interface thereon by the display mode; the image matching unit receives the tag of the first image from the import unit, identifies the imaging information of the first image in the first imaging data group according to the tag, selects a second image with the corresponding imaging information from a second imaging data group according to a pre-defined rule, and informs the monitor to display the second image; the monitor simultaneously and correspondingly displays the second image on the display interface by the display mode as same as that of the first image, wherein the first imaging data group and the second imaging data group both contain multiple images of the same target object.

### CLAIM OF PRIORITY

This patent application claims priority from Chinese Application No. 201220128665.7 filed Mar. 30, 2012, which is hereby incorporated by reference.

### TECHNICAL FIELD

The present invention relates to the field of molecular imaging, and in particular a comparative image display system for molecular imaging.

### BACKGROUND

Benefiting from rapid advance in the modern computer technology, the modern imaging technologies such as X-ray imaging, Computerized Tomography (CT), Positron Emission Tomography (PET) and optical imaging, et cetera have been more and more widely used in the field of molecular imaging, so as to explore and diagnose for those body parts that cannot be examined externally without through surgical intervention. Currently, molecular imaging has become a key scientific research method in the live science studies.

The increasingly sophisticated imaging technology also helps to bring about a rapid development of the novel technology of molecular imaging in the biomedicine field. Molecular imaging is a technology used for in vivo qualitative and quantitative studies of biological processes at the cellular and molecular level. This technology is capable of displaying and measuring properties of in vivo biological processes at the cellular and molecular level, thus reveling in depth information about physical or pathological processes and providing effective means of a real-time, dynamic, detailed, non-invasive and targeted detection and tracing of diseases and their treatments. The main method of molecular imaging technology include optical imaging, nuclide imaging, magnetic resonance imaging, ultrasound imaging and CT imaging, et cetera.

Applications of such molecular imaging technologies show significant advantages compared with the conventional in vitro imaging technology. Firstly, molecular imaging reflects the spatial and chronological distribution of the cellular or genetic expression, thereby enabling the understanding of the relevant biological processes, specific genetic functions and the interactions. Secondly, since the long term repeated follow-up imaging of a research subject is made possible, the comparability of the data is also greatly increased, thus avoiding the influence of an individual difference on the test results. However, it is understandable that, with the increasingly widespread use of the molecular imaging technology, it is likely for a user to obtain a significant number of images from repeated multiple experiments under various conditions in order to acquire more comprehensive information. For each individual experiment, it is also possible that a large number of images are acquired under different imaging angles or spatial positions, and it is difficult to distinguish each image by the naked-eye. Thus, although the acquisition of the expected experiment results has become simpler due to the convenience of operating the imaging equipment, many practical problems will still be encountered by a user when use and analysis the imaging results in such a huge number.

For example, currently on most of the equipment, when it is necessary to find out the difference among images obtained from different experiments so as to conduct a study or analysis, a user must manually locate one image to be used for comparison by looking through the images one by one in a large number of the images, and then locate another comparable image in the same manual manner in the remainder of this large number of images. This process is time-consuming and labor-intensive, and the result may be inaccurate. Furthermore, most of the currently available devices only support manual placement of images on screen and manual adjustment of all images on the screen in order to identify the difference among the images. These elements hinder users from achieving an effective use of various molecular imaging technologies.

There is a need for a display device that is convenient for a user to compare the molecular imaging results.

### SUMMARY OF THE INVENTION

According to an aspect, a comparative image display system comprises a monitor, an import unit and an imaging matching unit. The import unit receives tags and displaying mode of a displayed first image selected by the user from a first imaging data group, and informs the monitor to display the first image on the display interface thereon by the display mode; the imaging matching unit receives the tags of the first image from the import unit, identifies the imaging information of the image from the first imaging data group according to the tags, selects a second image with the corresponding imaging information from a second imaging data group according to a pre-defined rule, and informs the monitor to display the second image; the monitor simultaneously and correspondingly displays the second image on the display interface in the display mode of the first image, wherein the first imaging data group and the second imaging data group both contain multiple images of the same target object.

Preferably, the comparative image display system also includes an operation matching unit, where in the import unit also receives an operation performed by the user to one of the first image or second image, and informs the monitor to display the change of this image caused by the operation; the operation matching unit receives the operation from the import unit, and informs the monitor to display the same change caused by the operation to the other of the second image or first image.

In some embodiments, the first imaging data group and the second imaging data group contain respectively multiple two-dimensional images of the target object and three-dimensional images obtained from the multiple two-dimensional images.

In some embodiments, when the first image is a two-dimensional image, the pre-defined rule includes that the imaging angle of the target object in the second image and the imaging angle of the target object in the first image are the same.

Preferably, the pre-defined rule also included that the second image and the first image are of the same imaging type.

In some embodiments of this new utility, the imaging type may be X-ray imaging, white-light imaging or fluorescence imaging.

In some embodiments of this new utility model, the display interface may be grid-like, and the grid used to display the second image and the grid used to display the first image are two contiguous grids in the same row or the same column.

In some embodiments of this new utility model, when the first image is a three-dimensional image, the display mode includes the spatial position and the rendering mode of the first image.

A molecular imaging device is also provided in this new utility model, and the molecular imaging device includes a comparative image display system as described in any of the previous descriptions.

By using the comparative image display system for molecular imaging provided by this new utility model, after a molecular imaging process of a large quantity of images, users may conveniently acquire multiple comparable images to be automatically displayed on the display interface, thus reducing the trouble of manual selection by a user from the large number of images. At the same time, the accuracy of the comparative analysis result is also increased, thereby helping user to take more advantage from molecular imaging technology for the purpose of molecular diagnoses or research. According to the comparative image display system for molecular imaging of this new utility model, when one of the images for comparison is changed by the user, the system will automatically apply the same change to all other images, thus making the operation during the process of image comparison more convenient and flexible.

These and other objects, features and advantages of the present invention will become apparent in light of the detailed description of the embodiments thereof, as illustrated in the accompanying drawings. In the figures, like reference numerals designate corresponding parts.

### DESCRIPTION OF THE DRAWINGS

FIG. 1 illustrates a comparative image display system for molecular imaging according to a first embodiment;

FIG. 2 illustrates a first image displayed by the comparative image display system for molecular imaging;

FIG. 3 illustrates a first image and a second image displayed by the comparative image display system for molecular imaging according to this new utility model; and

FIG. 4 is a structural diagram of the comparative image display system for molecular imaging according to a second embodiment.

### DETAILED DESCRIPTION

In order to make the above mentioned objectives, features and advantages of this new utility more apparent and understandable, the new utility model is further explained with reference to the drawings and detailed embodiments. It should be understood that, all structures in the drawings are demonstrative and not restrictive, and in order that the principles of this new utility model may be best understood by an ordinary technical person in the field, the drawings are not necessarily drawn according to the actual proportion.

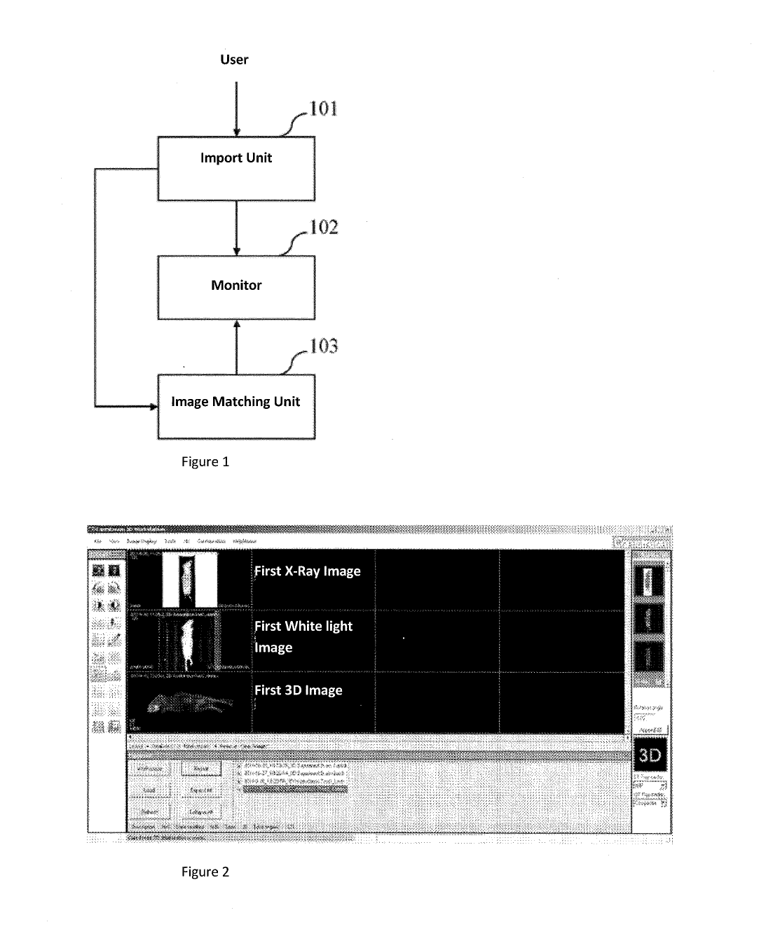

FIG. 1 illustrates a comparative image display system for molecular imaging. Generally speaking, this new utility model is applicable to the situations in which a user needs to view and compare two or more than two images of the same imaging attributes (properties) on a display/monitor. For example, when a user needs to observe changes of a lesion at a specific location inside the body of a live target object over a period of time, imaging scan of the observed object at each pre-defined point-in-time using various molecular imaging devices (e.g., CT, PET, X-Ray, optical etc.,) may be conducted. The imaging result of each point-in-time may be saved as one image group. By correspondingly displaying the images of the same imaging method and taken from the same imaging angle in each image group on one interface, the user can clearly see the changes of the lesion by comparing the images. This new utility model automatically displays each image that needs comparing in each image group.

As shown in FIG. 1, the comparative image display system for molecular imaging includes an import unit 101, a monitor 102 and an image matching unit 103. For example, when a user has completed multiple groups of imaging scan of a target object, for example a live object with a lesion, at the different times over one period, he/she can select at least two groups of imaging data from the acquired images and associate them with the comparative image display system. In some embodiment examples, such associations may refer to enabling the comparative image display system to visit the relevant imaging data in each group via an identification index, and not necessarily store the actual large number of images in the memory unit of the comparative image display system. The imaging data may include the basic data required of displaying each image itself in each group in a digital format on the monitor, such as pixel information etc., and may also include information such as sample number, scanning time, imaging method (e.g., white light, X-ray, etc.), imaging angle, 3D spatial position etc. One of ordinary skill will understand that imaging data of each group used in the same display system usually will contain the same types of information in the same format.

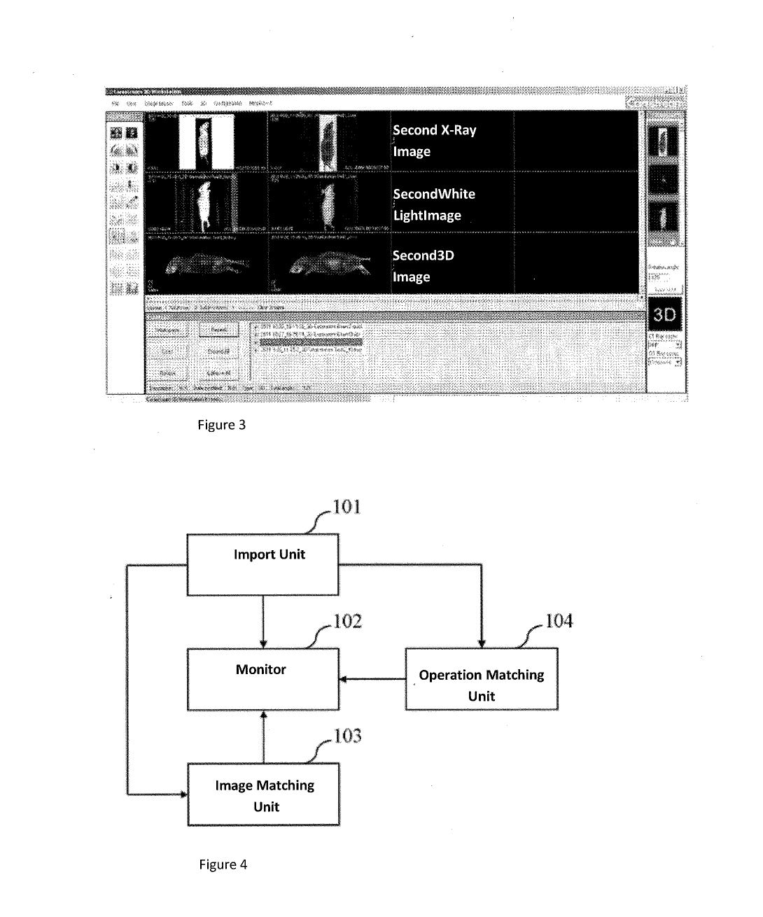

When a user needs to display for example the corresponding images of two imaging data groups on the display interface at the same time for viewing, the comparative displaying system for molecular imaging provided in this new utility model will firstly receive, via the import unit 101, the first image to be displayed which is selected by the user from the imaging data of the first group. During the use, a user may select more than one image from the same group of imaging data for displaying, to be used as the standard of display. In particular, the import unit 101 receives the information including the tags and display mode of this first image from the user. For example, the tag may be the file name of the first image, or other information which characterizing this first image, thus enabling the import unit 101 and the image matching unit 103 to identify the image information (attributes) of the first image from the first imaging data group via this tag, or the data required for displaying this first image. When informing the monitor to display this first image, the import unit 101 may for example associate the required data for displaying the first image and the user-defined display mode with the monitor 102. At the same time, the import unit 101 is also configured so as to transfer the tag of the first image to the image matching unit 103. The display mode of the first and second images is further explained below with a reference to FIGS. 2 and 3.

Following receipt of the tag of the first image from the import unit 101, the image matching unit 103 identifies the imaging information of this first image among the first imaging data group according to this tag, for example the file name used for saving the first image. For example, this imaging data may be the imaging type of the first image, the imaging angle in the first image of the observed target object, etc. Next, the image matching unit 103 may select the second image of the corresponding imaging information from the second imaging data group according to a pre-defined rule.

For the convenience of narrative, we firstly assume the first imaging data group and second imaging data group contain respectively multiple two-dimensional images of the target object and the three-dimensional images obtained from the multiple two-dimensional images. However, it should be understood that this application of focusing on three-dimensional image reconstruction is only demonstrative, and comparative image display system provided by this new utility model may be used in situations of molecular imaging in which comparisons among a large number of images are required, not just limited to the situation of three-dimensional reconstruction. Normally, when performing three-dimensional reconstruction based on a large number of two-dimensional images acquired from a target object, the object is subjected to a rotation of a range of 0-360° in relation to a reference plane. Two-dimensional images are acquired when the target object is in different angles, and images of all angles are combined to compile the three-dimensional image. Under this circumstance, the first imaging data group and the second imaging data group may refer to the data acquired respectively during the three-dimensional reconstruction processes for the target object via a substantially consistent process but at different times.

Thus, when the first image selected by the user is the two-dimensional image of the first imaging data group, the imaging information may include the imaging angle of the target object in this image, and the pre-defined rule may include that the imaging angle in the second image is the same as the imaging angle in the first image. It is easy to understand that, a comparison under this same imaging angle will bring important meaning to molecular diagnoses and scientific studies alike. In addition, the pre-defined rule may also include that the second image and the first image are of the same imaging type, this imaging type may be for example X-ray imaging, white light imaging or fluorescence imaging.

For example, when selecting the second image of the corresponding imaging information, the image matching unit 103 may first search the imaging angle information of each image one by one in the second imaging data group. Once the images of the same angle are identified, the imaging type information of these images will then be searched one by one. Once both two items match the first image, the image will be identified as a second image for displaying. Under the circumstance that multiple first images are selected by a user, the image matching unit 103 will search each second image corresponding to each first image respectively and in sequence.

Once the second image is identified, similar to the import unit 101, the image matching unit 103 associates the data required for displaying this second image with the monitor 102, and the monitor is configured so as to simultaneously and correspondingly display the second image on the display interface thereon in the display mode of the first image.

Thus, once a standard image, namely the first image, has been selected by the user to be displayed first, the comparative image display system provided by this new utility model will automatically and simultaneously display the corresponding images need comparison in other imaging data groups provided by the user on the display interface of the monitor for the comparative analysis by the user.

FIG. 2 depicts a first image displayed by the comparative image display system for molecular imaging according to the new utility model. As described above, the first image may be more than one, with the only requirement being they are selected from the same imaging data group. Three first images selected by the user are displayed in FIG. 2, which include a first X-ray image, a first white light image and a first three-dimensional image. In this example, the first X-ray image and the first white light images are the two-dimensional images used for the three-dimensional reconstruction, and the lowest three-dimensional image is the result of the reconstruction. As illustrated in FIG. 2, the interface of the monitor is grid-like, and the three first images are displayed respectively in each grid of the first column. In this embodiment, the comparative image display system provided by this new utility model allows user to place these images manually and directly into such a grid, wherein the images may be placed by column or by line, depending on the preference of the user.

FIG. 3 shows the first images and the second images displayed by the comparative display system for molecular imaging according to this new utility model. As shown in FIG. 3, when the first images are displays in the appropriate positions and by the display mode selected by the user, the comparative image display system for molecular imaging provided by this new utility model will automatically select the second images from the second imaging data group corresponding to the first images according to the aforesaid process, and display these images at the positions convenient for the comparison by the used. In FIG. 3, the three second images are displayed respectively in the next column corresponding to the first image. If the first images are arranged in a line, then the second images will be displayed in the next line. In the situation of more than two data groups, the third, fourth images, and so on may be identified by the same method and displayed in sequence in the next line or next column.

In this example, the display mode of the first images identified by the user as the standard may include the resolution of each grid, for example displaying the image in a grid 40×50 pixels according to the requirement. The display mode may also include the brightness, for example displaying the image in a grid of window width 1000/window level 500. It should be understood that these display modes are only demonstrative, and the comparative image display system provided by this new utility model supports any display dimensions commonly used in this field. Additionally, when the first image is one of the three-dimensional images, the user may also select the spatial position for the display of the first image, including projective angle, spatial sectional angle, and rendering mode. The second three-dimensional image will be displayed in the mode of the same spatial position and rendering mode. Thus, it is convenient for the user to distinguish the difference between the two, and thereby obtaining an accurate comparative result.

FIG. 4 is a structural diagram of the comparative image display system for molecular imaging according to the second embodiment example of this new utility model. Different from the example shown in FIG. 1, this comparative image display system also includes an operation matching unit 104. In practical applications, after the images need to be compared have already appeared on the display interface, it is possible that user may need to adjust the display mode of the displayed images, for example zoom in or zoom out, in order to acquire more information of interest. Under this circumstance, according to the embodiment example shown in FIG. 4, the import unit 101 receives operations performed by the user on one of the displayed images, such as zoom in, zoom out, adjusting resolution or brightness, changing rendering mode, etc. Next, the import unit 101 will inform the monitor 103 to display the changes of this image caused by these operations, and at the same time transfers these operations to the operation matching unit 104. Following receipt of the operations from the import unit, the operation matching unit will inform the monitor 102 to display the corresponding changes on other images caused by these operations. Therefore, in this comparative image display system for molecular imaging provided according to this embodiment, when one of the comparative images is adjusted by the user, the system will automatically make the same adjustments to other images, thereby maintaining the consistency in all images and avoiding the cumbersome task of manual adjustment of the images one by one, providing an excellent operating experience to the user.

It should be stated that the above detailed embodiments are only for explaining the technical solution of this new utility model, but not for limiting the scope of this new utility model. Although the new utility mode is described in detail with the reference to the above detailed embodiments, it should be understood by an ordinary technical person of the field that, modifications and equivalent replacements may be made to these detailed embodiments and some parts of the technical features thereof without departing from the essence of this new utility model, and these modifications and replacements are all covered by the scope of patent protection stipulated by this new utility model application.

What is claimed is:

1. A comparative image display system for molecular imaging, comprising:
a monitor;
an import unit;
and a imaging matching unit, wherein
the import unit receives tags and displaying mode of a displayed first image selected by the user from a first imaging data group, and informs the monitor to display the first image on the display interface there on by the display mode;
the imaging matching unit receives the tags of the first image from the import unit, identifies the imaging information of the first image from the first imaging data group according to the tags, selects a second image with the corresponding imaging information from a second imaging data group according to a pre-defined rule, and informs the monitor to display the second image;
the monitor simultaneously displays the second image on the display interface in the display mode of the first image, wherein the first imaging data group and the second imaging data group both contain multiple images of the same target object.

2. The comparative image display system of claim 1, where the comparative image display system comprises an operation matching unit, and the import unit receives from the user an operation performed by the user to one of the first image or second image, and informs the monitor to display the change of this image caused by the operation; the operation matching unit receives the operation from the import unit, and informs the monitor to display the same change caused by the operation to the other of the second image or first image.

3. The comparative image display system of claim 1, where the first imaging data group and the second imaging data group contain respective multiple two-dimensional images of the target object and three-dimensional images obtained from the multiple two-dimensional images.

4. The comparative image display system of claim 3, where when the first image is a two-dimensional image, the pre-defined rule includes that the imaging angle of the target object in the second image and the imaging angle of the target object in the first image are the same.

5. The comparative image display system according to claim 4, where the pre-defined rule also includes that the second image and the first image are of the same imaging type.

6. The comparative image display system according claim 5, where the imaging type is X-ray imaging, white-light imaging or fluorescence imaging.

7. The comparative image display system according to claim 1, where the display interface is grid-like, and the grid used to display the second image and the grid used to display the first image are two contiguous grids in the same row or the same column.

8. The comparative image display system according to claim 3, where when the first image is a three-dimensional image, the display mode includes the spatial position and the rendering mode of the first image.
